(19) United States
(12) Patent Application Publication
(10) Pub. No.: US 2010/0082237 A1
(43) Pub. Date: Apr. 1, 2010

(54) JOURNAL SERVICE

(75) Inventor: Daniel H. Black, Issaquah, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/242,512

(22) Filed: Sep. 30, 2008

(51) Int. Cl. G01C 21/00

(52) U.S. Cl. 701/207

(57) ABSTRACT

A journal service is described. In embodiment(s), a portable device includes position logic that can determine spatial data corresponding to a location of the portable device. Temporal data that corresponds to the spatial data can also be logged. A journal service can determine context information that is associated with the spatial data and/or the temporal data when the portable device is or was proximate the location. The journal service can then create a journal event that is defined by the spatial data, the temporal data, and the context information.

### BACKGROUND

Mobile phones and other portable devices are common in our society and are increasingly used for not only communication, but to store different types of information and data, such as phone numbers, personal information, business information, documents, pictures, and other types of data. Mobile phones and other communication-enabled portable devices typically have connectivity to a voice network for voice communications, and may also be connected to a data network for Internet access and data communication. In addition, such devices are increasingly enabled for GPS (Global Positioning System) communication to receive global positioning data.

### SUMMARY

This summary is provided to introduce simplified concepts of a journal service. The simplified concepts are further described below in the Detailed Description. This summary is not intended to identify essential features of the claimed subject matter, nor is it intended for use in determining the scope of the claimed subject matter.

A journal service is described. In embodiment(s), a portable device includes position logic that can determine spatial data corresponding to a location of the portable device. Temporal data that corresponds to the spatial data can also be logged. A journal service can determine context information that is associated with the spatial data and/or the temporal data when the portable device is or was proximate the location. The journal service can then create a journal event that is defined by the spatial data, the temporal data, and the context information.

In other embodiment(s) of a journal service, the spatial data for a journal event can be determined from a global positioning system, and the temporal data can be logged as a date and time that corresponds to when the portable device is or was proximate a particular location. The journal service can determine the context information for a journal event from details of an appointment on a calendar, from details about a contact that is identified in an appointment on the calendar, and/or from details about a contact that is determined from contacts data. Alternatively or in addition, the journal service can initiate a request for the context information and receive the context information as an input to the portable device, such as from a user of the portable device.

In other embodiment(s) of a journal service, the journal service can develop a routine, such as for a user of the portable device, based on multiple journal events. The journal service can then also identify a deviation from the routine based on a journal event that is different from the journal events used to develop the routine. The journal service can also request an advertisement that corresponds to a location along a route that is part of the routine. Similarly, the portable device can receive an advertisement that is targeted to a user of the portable device where the advertisement corresponds to the location along the route. The journal service can also be implemented to create and/or update a blog (i.e., Web log) based on the multiple journal events.

### BRIEF DESCRIPTION OF THE DRAWINGS

Embodiments of a journal service are described with reference to the following drawings. The same numbers are used throughout the drawings to reference like features and components:

FIG. 1 illustrates an example system in which embodiments of a journal service can be implemented.

FIG. 2 illustrates another example system in which embodiments of a journal service can be implemented.

FIG. 3 illustrates example method(s) for a journal service in accordance with one or more embodiments.

FIG. 4 illustrates various components of an example service that can implement embodiments of a journal service.

FIG. 5 illustrates various components of an example device that can implement embodiments of a journal service.

### DETAILED DESCRIPTION

Embodiments of a journal service provide an eventing mechanism to create and update a journal of events that correlate to a routine of a user that carries along a portable device, such as a mobile phone that includes GPS or another system used to ascertain location information. The journal service can create journal events that are defined by spatial data, temporal data, and context information all related to a location of the portable device. The journal service can develop the routine for the user of the portable device based on multiple journal events. The journal service can then also identify a deviation from the routine based on a journal event that is different from the journal events used to develop the routine.

While features and concepts of the described systems and methods for a journal service can be implemented in any number of different environments, systems, and/or various configurations, embodiments of a journal service are described in the context of the following example systems and environments.

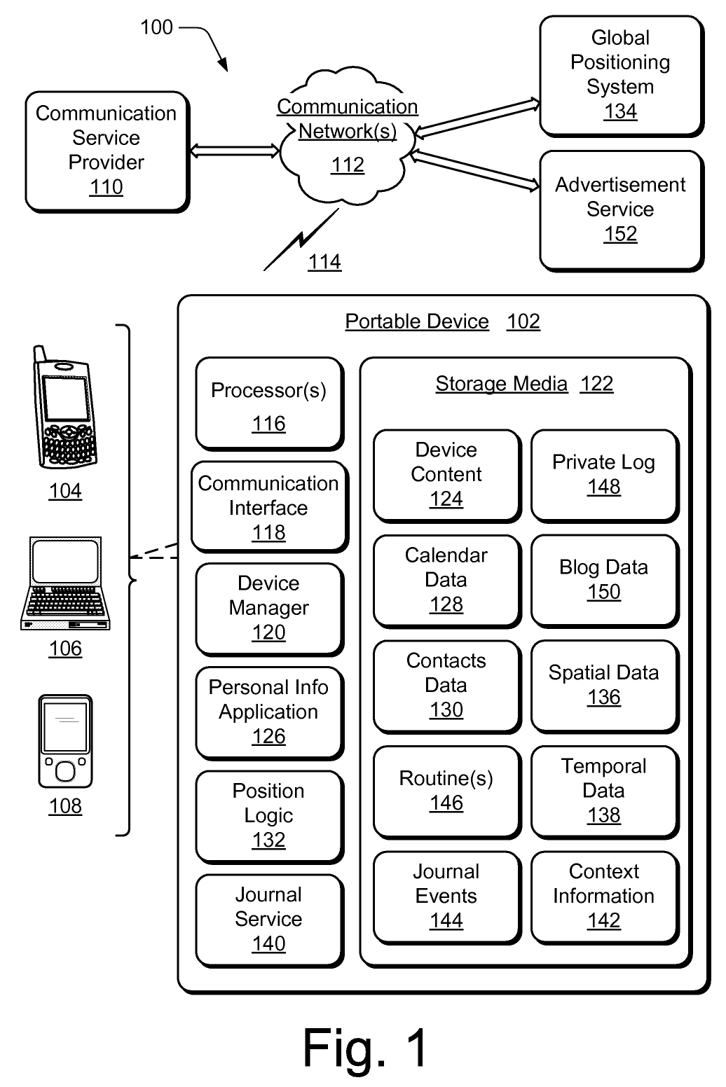

FIG. 1 illustrates an example system 100 in which various embodiments of a journal service can be implemented. Example system 100 includes a portable device 102 that is implemented for data and/or voice communications, such as any one or combination of a mobile phone 104 (e.g., cellular, VoIP, WiFi, etc.), a portable computer device 106, a media device 108 (e.g., a personal media player, portable media player, etc.), and/or any other wireless, portable device that can receive data in any form of audio, video, and/or image data. Each of the various portable devices include an integrated display and selectable input controls via which a user can input data.

Example system 100 includes a communication service provider 110 that provides for mobile data and/or voice communications. For example, the communication service provider 110 may be a cell-phone service provider, an Internet service provider, and/or a combination thereof. The communication service provider 110 enables data and/or voice communications for any type of a mobile device or portable device 102 (e.g., via cellular, VoIP, WiFi, etc.), and/or any other wireless media or communication device that can receive data, voice, or media content in any form of audio, video, and/or image data.

The portable device 102 and communication service provider 110 are implemented for communication via communication network(s) 112 that can include any type of a data network, voice network, broadcast network, an IP-based network, and/or a wireless network 114 that facilitates data and/or voice communications. The communication network(s) 112 can be implemented using any type of network topology and/or communication protocol, and can be represented or otherwise implemented as a combination of two or more networks. Any one or more of the arrowed communication links facilitate two-way data communication, such as from the portable device 102 to the communication service provider 110 and vice-versa.

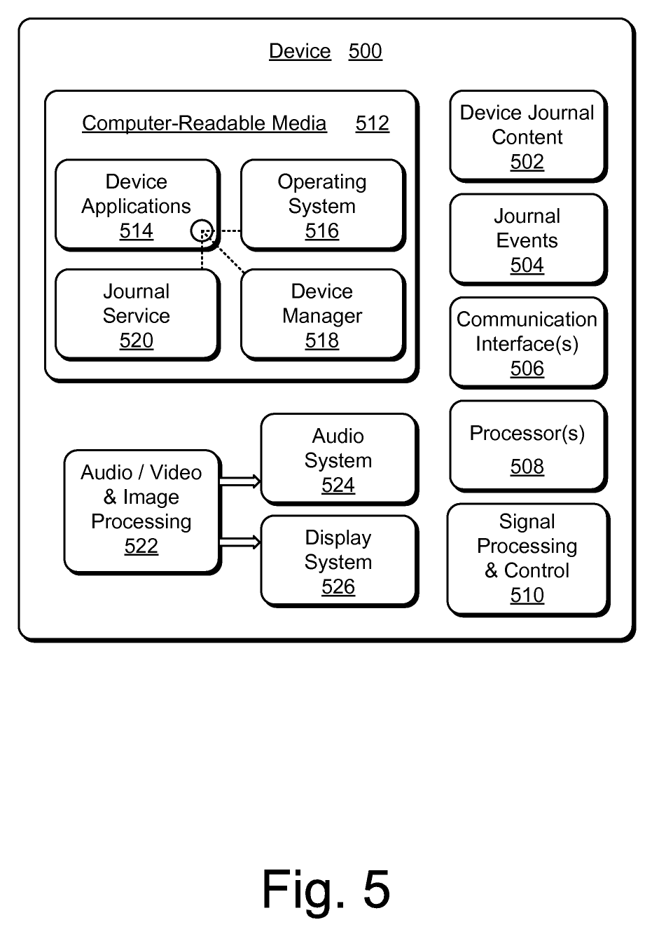

In this example, portable device 102 includes one or more processors 116 (e.g., any of microprocessors, controllers, and the like), a communication interface 118 to receive and/or communicate data and voice communications, and a device manager 120 (e.g., a control application, software application, signal processing and control module, etc.). The portable device 102 can also be implemented with any number and combination of differing components as further described with reference to the example device shown in FIG. 5. A portable device may also be associated with a user or owner (i.e., a person) and/or an entity that operates the device such that a portable device describes logical devices that include users, software, and/or a combination of devices.

The portable device 102 includes storage media 122 to store or otherwise maintain various data, information, and media content. The storage media 122 can be implemented as any type of memory, random access memory (RAM), a nonvolatile memory such as flash memory, read only memory (ROM), a removable storage device, and/or other suitable electronic data storage. The storage media 122 can maintain device content 124, such as configuration settings of the device, media content stored on the device, information associated with a user of the device (e.g., user profile data), business or personal information, documents, and/or messaging content that has been received and/or communicated via the device. Media content stored on the portable device 102 can include any type of data and audio, video, and/or image media content.

In this example, portable device 102 includes a personal information application 126 that can be implemented to manage information for a calendar (e.g., calendar data 128), contacts (e.g., contacts data 130), email, tasks, notes, and the like. Portable device 102 also includes position logic 132 that can be implemented to initiate communication with a global positioning system (GPS) 134 to determine spatial data 136 that corresponds to a location of the portable device 102. For example, the position logic 132 can periodically determine a global position or location of the portable device 102 as a user of the device transports or carries it along from one location to another. In various embodiments, the spatial data 136 that corresponds to a location of the portable device 102 can be based on GPS, assisted GPS that includes position data obtained from the communication service provider 110, and/or other systems that provide location awareness for portable device 102.

A user that has a mobile phone 104 is likely to carry the phone throughout the day, such as from home, to work, to run errands, out for the evening, and back to home. The position logic 132 can log the various locations of the portable device 102 throughout the day, and can also log temporal data 138 that corresponds to the spatial data 136 for a location. For example, the position logic 132 can determine the spatial data 136 for a particular location, and then log the date and time that the portable device 102 is or was proximate the particular location.

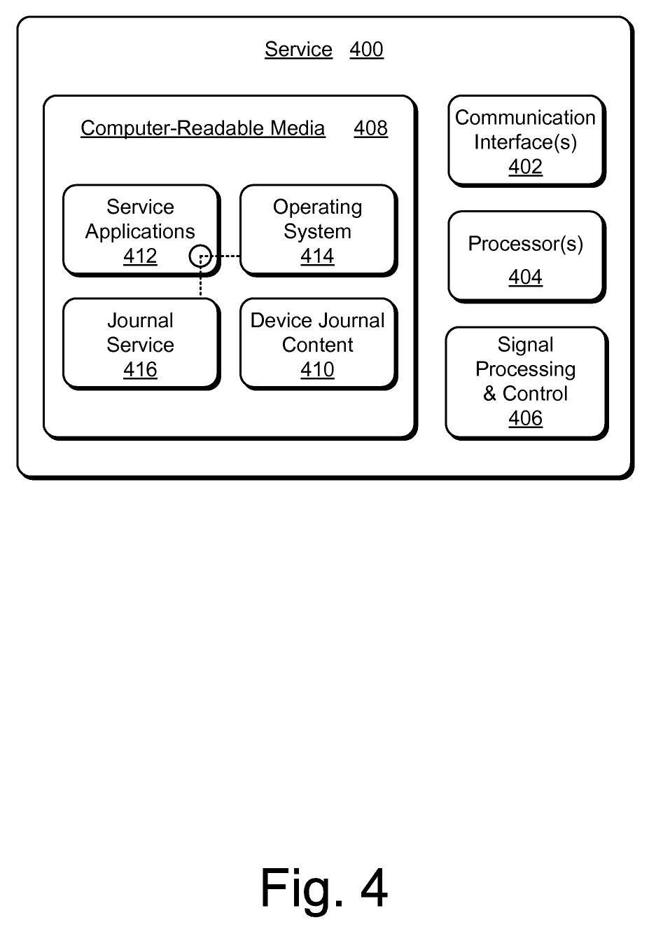

Portable device 102 also includes a journal service 140 that can be implemented as computer-executable instructions and executed by the processors 116 to implement various embodiments and/or features of a journal service. The device manager 120 can interface with the journal service 140 to communicate journal service data and/or information over the communication network(s) 112 via the communication interface 118. In various embodiments, the journal service 140 can be implemented as several components or modules distributed to implement the embodiments of a journal service as described herein. In addition, a journal service can be implemented with any number and combination of differing components as further described with reference to the example service shown in FIG. 4.

In various embodiments, the journal service 140 can be implemented to determine context information 142 that is associated with spatial data and/or temporal data when the portable device is or was proximate a location. For example, the journal service 140 can determine the context information 142 from any one or combination of the details of an appointment on a calendar (e.g., calendar data 128), from details about a contact that is determined from contacts data 130, and from details about a contact that is identified in an appointment on a calendar (e.g., calendar data 128 and contacts data 130). The journal service 140 can also determine the context information 142 from geo-tagged photos, mapped location information, Internet information, news events, other journal information, and/or from the user of the device. For example, the journal service 140 can initiate a request that the user of the device confirm and/or provide the context information 142. Additionally, the user of the device can initiate adding to the context information as data input to the device.

As the user of the mobile phone 104 carries the phone throughout the day, the journal service 140 tracks and logs location information (e.g., the spatial data 136) as well as the date and time of day (e.g., the temporal data 138). The journal service 140 determines the context information 142 and can then create journal events 144 that are each defined by the respective spatial data 136, temporal data 138, and context information 142. The journal service 140 can also develop a routine (or routines) 146 based on multiple journal events 144, and can subsequently identify a deviation from a routine based on a journal event that differs from the routine.

The journal service 140 can identify places and events that occur in a similar location and create contextual relationships as the journal events 144. For example, the locations home and work, as well as the locations along a route or pattern that is part of the routine 146 for the user of the device, would be determined rather quickly. After that, deviations can be identified when the user of the device goes to dinner, a movie, shopping, or out with friends which are deviations from the routine 146 that the journal service 140 has learned. For example, the user of portable device 102 may go to a new restaurant with a friend to celebrate a birthday and carry the portable device along. The position logic 132 can determine the spatial data 136 that corresponds to the location of the new restaurant, and log the date and time (e.g., the temporal data 138) that corresponds to when the user was at the new restaurant (i.e., while the device 102 was at the new restaurant with the user).

The journal service 140 can then correlate the spatial data 136, the temporal data 138, the contact data 130 that corresponds to the friend, such as the friend's name and birthdate, and calendar data 128 for an appointment that includes the date, time, and an indication of having dinner with the particular friend. The journal service 140 can determine some of the context information 142 for the dinner at the new restaurant, such as the name and location of the new restaurant, the friend's name, and that the occasion was for the friend's birthday. In an embodiment, the friend may also carry a mobile device that portable device 102 communicates with to ascertain whether a calendar appointment on the friend's device includes the names of others that may have also attended the birthday occasion at the new restaurant.

Subsequent to the birthday dinner at the restaurant, such as a following day, the journal service 140 can initiate a request that the user of the device confirm the context information 142 that has been determined and/or provide additional context information. For example, the journal service 140 can initiate a dialogue with the user of the device to further determine additional context information about the deviation from a routine, such as whether the user thought the food at the new restaurant was good, whether a particular photo corresponds to the occasion, a preference for going back to the restaurant in the future, and to determine who else might have been with the user. A journal event 144 that is created to define the occasion in this example is then a mix of determined and confirmed context information 142.

A user of the portable device 102 can choose when and whether to respond to a request to enter context information when initiated by the journal service 140. For example, the journal service 140 may initiate a request for context information 142 about a particular location, and the user of the device can simply indicate that the location was not of importance. The journal service 140 can then disregard creating a journal event that corresponds to the particular location. In another example, the user of the device can input an indication to initiate the request for the context information at a later time. In an embodiment, the journal service 140 can also determine when a user of the device responds to requests for context information, and when the user does not. For example, the user might indicate that mid-mornings during scheduled business meetings, or early evenings when returning home from work are not when the user responds to requests. Alternatively, the journal service 140 may determine that a good time to initiate a request for context information is when the user is commuting home from work, or during the lunch hour. The user of the device can also poll the device at anytime to check whether the journal service 140 has any unresolved requests when the user has time to respond.

The journal service 140 can also be implemented to create and/or update a private log 148 of the journal events 144 which can be reviewed by the user of the device much like a journal or diary. Alternatively or in addition, the journal service 140 can save blog data 150 and update or publish the blog data as a blog (i.e., Web log). In various embodiments, each journal event 144 can be catalogued with a global identifier that can be utilized to correlate the journal events and/or exchange journal events between the portable devices of multiple users.

The journal events 144, routine(s) 146, private log 148, and/or blog data 150 may be useful to a user of portable device 102 for various reasons. For example, the journal service 140 can create the journal events 144 of a vacation to create a journal or blog of the experience. The user might then review the journal (e.g., the journal events 144) for a reminder of the name of a restaurant or shop visited while on vacation. The user may also review the journal events 144 to recall the restaurant and movie the user went to for an anniversary. The journal service 140 can also create the journal events 144 for a business user to identify a sales route, routine efficiencies, or to notify the user of a particular client that has not been visited in a while.

In various embodiments, the journal service 140 can be implemented to initiate anonymous communication of the journal events 144 to an advertisement service 152 that correlates information about a particular location and/or a provider of goods or services. For example, the advertisement service 152 can determine how many people pass by a particular restaurant, at what time, and/or correlate the user reviews of the restaurant from information in the journal events received from multiple portable devices. Advertisements for a particular restaurant or business along a route that is part of the routine 146 for the user of the portable device 102 can then be delivered to the portable device 102 for the user. In an embodiment, the journal service 140 can initiate a request for an advertisement that corresponds to the location of a particular business along the route that is part of the routine 146. The portable device 102 can subscribe to pull down advertisements for various locations along a route, in a pattern, or as part of a routine.

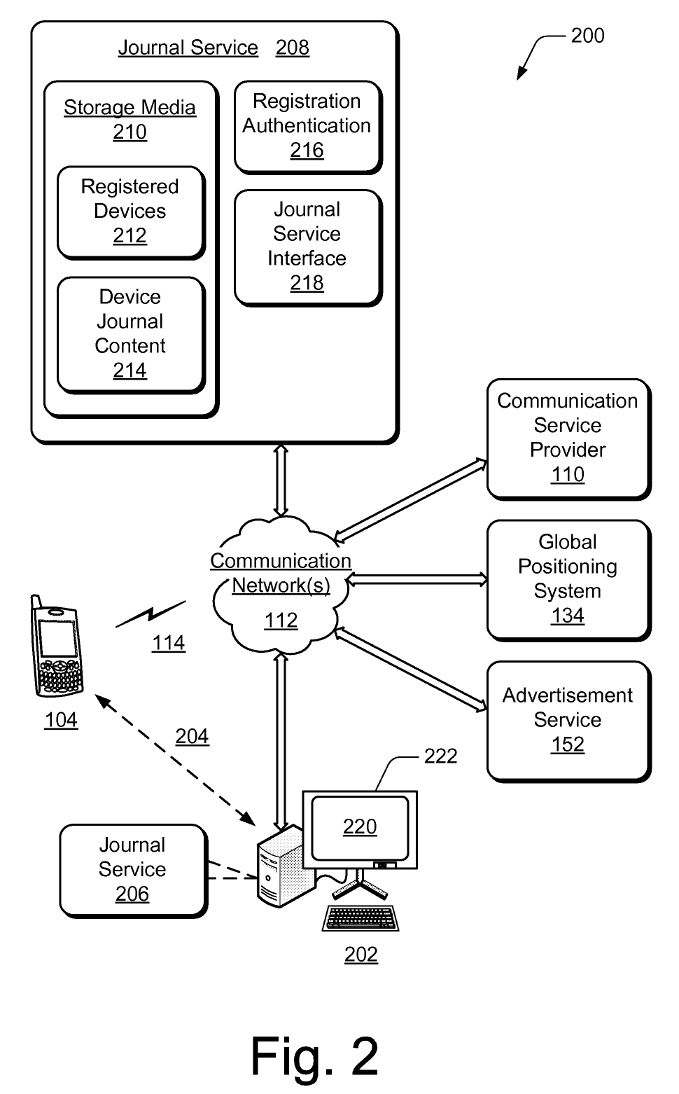

FIG. 2 illustrates another example system 200 in which various embodiments of a journal service can be implemented. Example system 200 includes a mobile phone 104, communication service provider 110, global positioning system 134, and advertisement service 152 that are all implemented for communication via the communication network(s) 112 and/or the wireless network 114. The mobile phone 104 is an example of portable device 102 that is described with reference to FIG. 1, and can be implemented with one or more processors, communication components, memory components, and signal processing and control circuits for data and/or voice communications. Implementations of the communication service provider 110, global positioning system 134, advertisement service 152, and communication network(s) 112 are also described with reference to FIG. 1.

Example system 200 includes a computer system 202 that may be synched 204 with the mobile phone 104, and can include a journal service 206 to implement the various embodiments and/or features of a journal service as described herein. The computer system 202 can include synched content from the mobile phone 104, such as calendar data, contacts data, a private log, blog data, and any other media content stored on the device, information associated with the user of the device, business or personal information, documents, and/or messaging content that has been received and/or communicated via the device. The journal service 206 can receive spatial data and temporal data that corresponds to a location of the mobile phone 104, and then determine context information as described with reference to journal service 140 shown in FIG. 1. The journal service 206 can also determine routines, create and/or update a private log or journal, and create and/or update a blog.

Example system 200 also includes a journal service 208 that can be implemented as a subscription-based service, an independent service, and/or a third-party service to implement the various embodiments of a journal service as described herein. Alternatively, the journal service 208 can be implemented as a component or service of the communication service provider 110, and optionally, be made available as a service or feature of a mobile phone service contract. In addition, the journal service 140 can be implemented with any number and combination of differing components as further described with reference to the example service shown in FIG. 4.

In this example, journal service 208 includes storage media 210 to store or otherwise maintain various data and media content, such as a database of registered devices 212 and device journal content 214. The device journal content 214 that is maintained by the storage media 210 can include spatial data, temporal data, context information, journal events, blog data, and any other journal service data that is associated with a portable device, such as mobile phone 104. The database of registered devices 212 can include an identifier of the mobile phone 104 that is registered with the journal service 208 and/or registered via the communication service provider 110.

The journal service 208 can also include a feature for registration authentication 216 to verify a particular portable device for synchronized content updates. For example, a unique identifier can be established for a particular user that is associated with the mobile phone 104 and/or the computer system 202. The unique identifier can include any one or combination of a user identifier, a computer identifier, a phone identifier, a phone number, and any other identifier that can be utilized for registration authentication 216.

The journal service 208 can also include a journal service interface 218 that can be accessed via the computer system 202 or any other wired or wireless desktop or laptop computer, or similar computing device that is networked to access the journal service. The computer system 202 can include a user interface application to display a journal service user interface 220 on a display device 222 (e.g., an LCD or similar display device). A user or owner of a portable device, such as the mobile phone 104, can then access the journal service 208 via the journal service user interface 220 at the computer system 202.

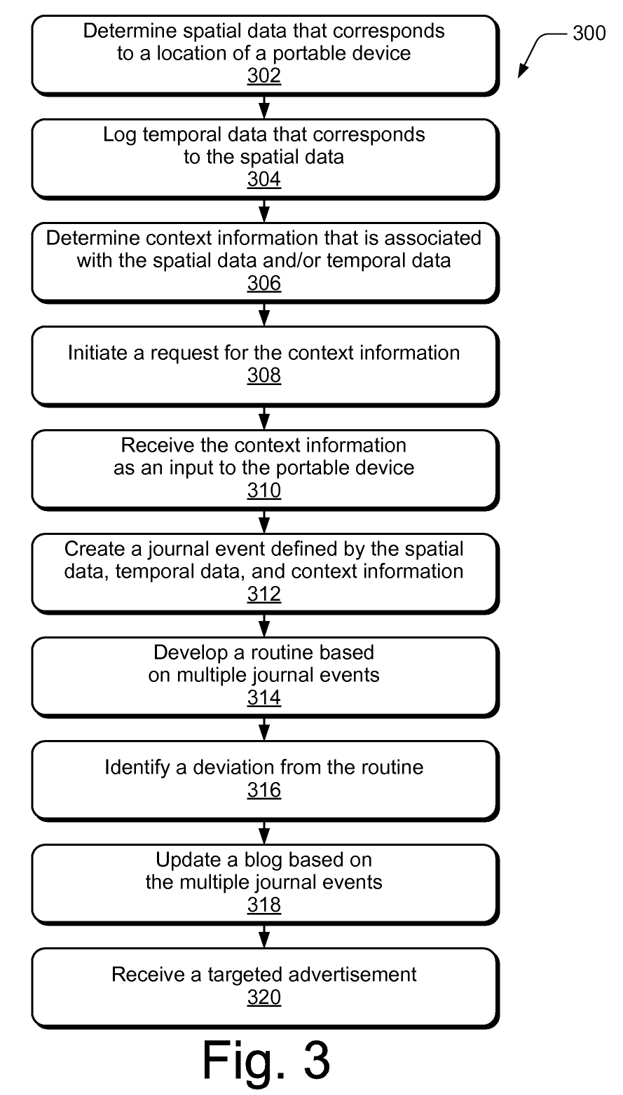

Example method 300 is described with reference to FIG. 3 in accordance with one or more embodiments of a journal service. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. Example method 300 may be described in the general context of computer-executable instructions, which can include software, applications, routines, programs, objects, components, data structures, procedures, modules, functions, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of a journal service. The order in which the method is described is not intended to be construed as a limitation, and any number of the described method blocks can be combined in any order to implement the method, or an alternate method.

At block 302, spatial data that corresponds to a location of a portable device is determined. For example, the position logic 132 at portable device 102 (FIG. 1) initiates communication with the global positioning system (GPS) 134 to determine spatial data 136 that corresponds to a location of the portable device 102. The position logic 132 periodically determines a global position or location of the portable device 102 as a user of the device transports or carries it along from one location to another.

At block 304, temporal data that corresponds to the spatial data is logged. For example, as the position logic 132 logs the various locations of the portable device 102 throughout a day, the position logic 132 logs the date and time that the portable device 102 is or was proximate a particular location.

At block 306, context information that is associated with the spatial data and/or the temporal data is determined. For example, the journal service 140 at portable device 102 determines context information 142 that is associated with the spatial data and/or the temporal data when the portable device is or was proximate a location. The journal service 140 determines context information 142 that includes details of the location that are determined from an appointment on a calendar (e.g., calendar data 128), from details about a contact stored as contact data 130 in the portable device, and/or from details about a contact that is identified in an appointment on a calendar in the portable device (e.g., calendar data 128 and contacts data 130). The journal service 140 also determines context information 142 from mapped location information, Internet information, news events, and/or other journal information.

At block 308, a request for the context information is initiated and, at block 310, the context information is received as an input to the portable device. For example, the journal service 140 initiates a request that a user of the device confirm and/or provide context information, and receives the context information as data input to the device. At block 312, a journal event is created that is defined by the spatial data, the temporal data, and the context information. For example, journal service 140 creates journal events 144 that are each defined by the respective spatial data 136, temporal data 138, and context information 142.

At block 314, a routine is developed based on multiple journal events and, at block 316, a deviation from the routine is identified. For example, journal service 140 develops a routine (or routines) 146 based on multiple journal events 144, and can subsequently identify a deviation from a routine based on a journal event that differs from the routine.

At block 318, a blog is updated based on the multiple journal events. For example, journal service 140 saves blog data 150 and updates or publishes the blog data as a blog (i.e., Web log). Alternatively or in addition, the journal service 140 creates and/or updates a private log 148 of the journal events 144 which can be reviewed by the user of the device much like a journal or diary.

At block 320, an advertisement that is targeted to a user of the portable device is received. For example, the journal service 140 initiates a request for an advertisement that corresponds to the location of a particular business along the route that is part of the routine 146, and receives an advertisement corresponding to the location or business.

FIG. 4 illustrates various components of an example service 400 that can implement various embodiments of a journal service, such as shown in FIG. 1 and/or FIG. 2. Service 400 can include one or more communication interfaces 402 that can be implemented as any one or more of a serial and/or parallel interface, a wireless interface, any type of network interface, a modem, and as any other type of communication interface for data and/or voice communication. The communication interfaces 402 provide a connection and/or communication links between service 400 and communication network(s) by which other communication, electronic, and computing devices can communicate with service 400.

Service 400 can include one or more processors 404 (e.g., any of microprocessors, controllers, and the like) which process various computer-executable instructions to control the operation of service 400 and to implement embodiments of a journal service. Alternatively or in addition, service 400 can be implemented with any one or combination of hardware, firmware, or fixed logic circuitry that is implemented in connection with signal processing and control circuits generally identified at 406.

Service 400 can also include computer-readable media 408, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like.

Computer-readable media 408 provides data storage mechanisms to store various types of information and/or data related to operational aspects of service 400, such as device journal content 410, and provides storage for various service applications 412. For example, an operating system 414 can be maintained as a computer application with the computer-readable media 408 and executed on the processors 404. The service applications 412 can also include a journal service 416. In this example, the service applications 412 are shown as software modules and/or computer applications that can implement various embodiments of a journal service.

Although not shown, service 400 can include a system bus or data transfer system that couples the various components within the service. A system bus can include any one or combination of different bus structures, such as a memory bus or memory controller, a peripheral bus, a universal serial bus, and/or a processor or local bus that utilizes any of a variety of bus architectures.

FIG. 5 illustrates various components of an example device 500 that can be implemented as any form of a mobile communication, computing, electronic, and/or media device to implement various embodiments of journal service. For example, device 500 can be implemented as a mobile phone or computer device as shown in FIG. 1 and/or FIG. 2. In various embodiments, device 500 can be implemented as any one or combination of a wireless or mobile phone, a portable computer device, and/or as any other type of mobile device that may be implemented for data and/or voice communications.

Device 500 can include device journal content 502, such as spatial data, temporal data, and context information, and can include journal events 504 and/or any other journal service data that may be stored on the device. Device 500 further includes one or more communication interfaces 506 that can be implemented for any type of data and/or voice communications.

Device 500 can include one or more processors 508 (e.g., any of microprocessors, controllers, and the like) which process various computer-executable instructions to control the operation of device 500 and to implement embodiments of a journal service. Alternatively or in addition, device 500 can be implemented with any one or combination of hardware, firmware, or fixed logic circuitry that is implemented in connection with signal processing and control circuits which are generally identified at 510.

Device 500 can also include computer-readable media 512, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like.

Computer-readable media 512 provides data storage mechanisms to store the device journal content 502 and the journal events 504, as well as various device applications 514 and any other types of information and/or data related to operational aspects of device 500. For example, an operating system 516 can be maintained as a computer application with the computer-readable media 512 and executed on the processors 508. The device applications 514 can also include a device manager 518 and a journal service 520. In this example, the device applications 514 are shown as software modules and/or computer applications that can implement various embodiments of a journal service.

Device 500 can also include an audio, video, and/or image processing system 522 that provides audio data to an audio rendering system 524 and/or provides video or image data to a display system 526. The audio rendering system 524 and/or the display system 526 can include any devices or components that process, display, and/or otherwise render audio, video, and image data. The audio rendering system 524 and/or the display system 526 can be implemented as integrated components of the example device 500.

Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Although embodiments of a journal service have been described in language specific to features and/or methods, it is to be understood that the subject of the appended claims is not necessarily limited to the specific features or methods described. Rather, the specific features and methods are disclosed as example implementations of a journal service.

1. A method, comprising:
determining spatial data that corresponds to a location of a portable device;
logging temporal data that corresponds to the spatial data;
determining context information that is associated with at least one of the spatial data or the temporal data; and
creating a journal event that is defined by the spatial data, the temporal data, and the context information.

2. A method as recited in claim 1, further comprising developing a routine based on multiple journal events.

3. A method as recited in claim 2, further comprising identifying a deviation from the routine based on the journal event that is different than the multiple journal events.

4. A method as recited in claim 2, further comprising receiving an advertisement that is targeted to a user of the portable device, the advertisement corresponding to the location along a route that is part of the routine.

5. A method as recited in claim 2, further comprising updating a blog based on the multiple journal events.

6. A method as recited in claim 1, wherein the context information includes details of the location that are determined from an appointment on a calendar in the portable device.

7. A method as recited in claim 1, wherein the context information includes details about a contact that is identified in an appointment on a calendar in the portable device.

8. A method as recited in claim 1, wherein the context information includes details about a contact determined from contacts data stored in the portable device.

9. A method as recited in claim 1, further comprising:
initiating a request for the context information; and
receiving the context information as an input to the portable device.

10. A method as recited in claim 1, wherein the spatial data is determined from a global positioning system, and wherein the temporal data is logged as a date and time.

11. A portable device, comprising:
position logic configured to determine spatial data that corresponds to a location of the portable device, the position logic further configured to log temporal data that corresponds to the spatial data;
a journal service configured to:
determine context information that is associated with the spatial data when the portable device is proximate the location; and
create a journal event that is defined by the spatial data, the temporal data, and the context information.

12. A portable device as recited in claim 11, wherein the journal service is further configured to develop a routine based on multiple journal events.

13. A portable device as recited in claim 12, wherein the journal service is further configured to identify a deviation from the routine based on the journal event that is different than the multiple journal events.

14. A portable device as recited in claim 12, wherein the journal service is further configured to request an advertisement that corresponds to the location along a route that is part of the routine.

15. A portable device as recited in claim 11, wherein the journal service is further configured to update a blog based on the multiple journal events.

16. A portable device as recited in claim 11, wherein the journal service is further configured to determine the context information from details of an appointment on a calendar.

17. A portable device as recited in claim 11, wherein the journal service is further configured to determine the context information from details about a contact that is identified in an appointment on a calendar.

18. A portable device as recited in claim 11, wherein the journal service is further configured to determine the context information from details about a contact that is determined from contacts data.

19. A portable device as recited in claim 11, wherein the journal service is further configured to initiate a request for the context information and receive the context information as an input to the portable device.

20. A portable device as recited in claim 19, wherein the position logic is further configured to initiate communication with a global positioning system to determine the spatial data.
